(19) United States
(12) Patent Application Publication
(10) Pub. No.: US 2013/0165168 A1
(43) Pub. Date: Jun. 27, 2013

(54) POPULATION CHARACTERISTICS DERIVED FROM CONTROL SIGNALS ON WIRELESS COMMUNICATION NETWORKS

(71) Applicants: Kosol Jintaseranee, San Jose, CA (US); Phyllis J. Reuther, Woodside, CA (US); Hui Zang, Cupertino, CA (US); Soshant Bali, San Mateo, CA (US)

(72) Inventors: Kosol Jintaseranee, San Jose, CA (US); Phyllis J. Reuther, Woodside, CA (US); Hui Zang, Cupertino, CA (US); Soshant Bali, San Mateo, CA (US)

(73) Assignee: Sprint Communications Company L.P., Overland Park, KS (US)

(21) Appl. No.: 13/337,702

(22) Filed: Dec. 27, 2011

(51) Int. Cl. H04W 92/00; H04B 7/24

(52) U.S. Cl. 455/507

(57) ABSTRACT

Embodiments disclosed herein provide systems and methods for deriving population counts and device flow characteristics on wireless communication networks. In a particular embodiment, a method provides receiving a first control signal transmitted by a first base station serving a first wireless sector and receiving a second control signal transmitted by a second base station serving a second wireless sector. The method further provides deriving a population count of a geographic area using device identifiers enumerated within the first and second control signals.

### TECHNICAL BACKGROUND

Base stations in wireless communication networks use control signals to transfer basic information to connected wireless devices. This information may include notifications of incoming calls, messages, or data. Once a wireless device receives a notification message the wireless device may be assigned a traffic channel in order to perform necessary actions in accordance with the control signal notification.

All wireless devices capable of receiving a control signal are able to see all communications broadcast on the control signal. However, notification messages are directed to wireless devices based on identifiers assigned to each wireless device. Thus, even though all wireless devices can see all notifications, only the wireless device with a particular identifier responds to a notification directed to that particular identifier. Additionally, while all devices can read all identifiers broadcast on the control signal any further information regarding the wireless device that is assigned a particular identifier remains unknown to those other devices.

### OVERVIEW

Embodiments disclosed herein provide systems and methods for deriving population counts and device flow characteristics on wireless communication networks. In a particular embodiment, a method provides receiving a first control signal transmitted by a first base station serving a first wireless sector and receiving a second control signal transmitted by a second base station serving a second wireless sector. The method further provides deriving a population count of a geographic area using device identifiers enumerated within the first and second control signals.

### BRIEF DESCRIPTION OF THE DRAWINGS

FIG. 1 illustrates a wireless communication system for deriving population counts and device flow characteristics on wireless communication networks.

FIG. 2 illustrates the operation of the wireless communication system for deriving population counts and device flow characteristics on wireless communication networks.

FIG. 3 illustrates a wireless communication system for deriving population counts and device flow characteristics on wireless communication networks.

FIG. 4 illustrates the operation of the wireless communication system for deriving population counts and device flow characteristics on wireless communication networks.

FIG. 5 illustrates the operation of the wireless communication system for deriving a count of dormant wireless devices.

FIG. 6 illustrates a wireless communication system for deriving population counts and device flow characteristics on wireless communication networks.

FIG. 7 illustrates a wireless communication system for deriving population counts and device flow characteristics on wireless communication networks.

FIG. 8 illustrates a population monitor system for deriving population counts and device flow characteristics on wireless communication networks.

### DETAILED DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

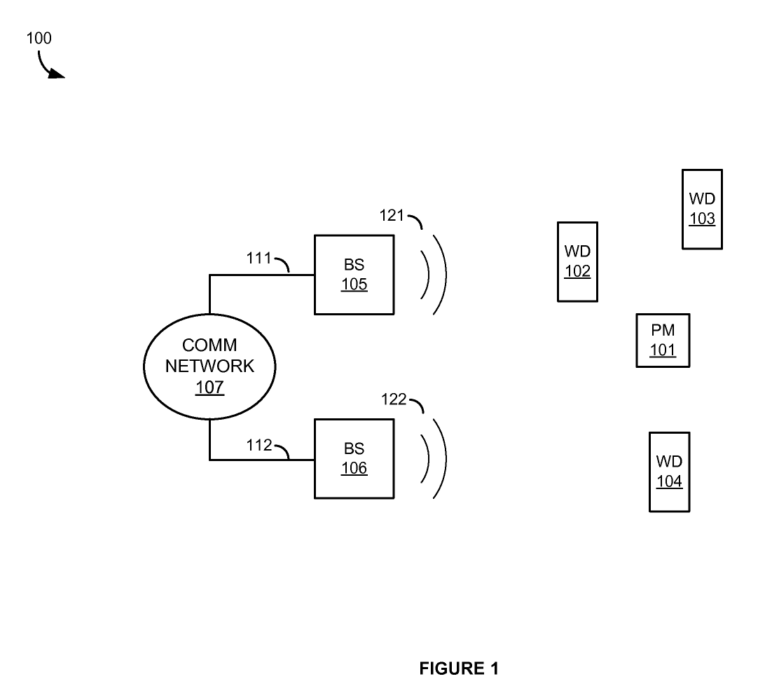

FIG. 1 illustrates wireless communication system 100 for deriving population counts and device flow characteristics on wireless communication networks. Wireless communication system 100 includes population monitor system 101, wireless communication devices 102-104, base stations 105 and 106, and communication network 107. Base station 105 and communication network 107 communicate over communication link 111. Base station 106 and communication network 107 communicate over communication link 112.

In operation, base stations 105 and 106 broadcast control signals in wireless sectors 121 and 122, respectively. These control signals from base stations 105 and 106 contain information for wireless devices 102-104 to communicate with communication network 107 via base stations 105 and 106. For example, a control signal may include a paging signal, pilot signal, digital rate control signal, or any other type of control signal on a wireless communication network including combinations thereof. Included in the control signal information from each base stations 105 and 106 are device identifiers for wireless devices communicating with each respective base station. For example, if wireless device 102 is registered to communicate with base station 105, then the control signal from base station 105 will include a device identifier for wireless device 102. Similarly, if wireless device 102 is registered to communicate with base station 106, then the control signal from base station 106 will also include a device identifier for wireless device 102.

While the device identifiers referred to above are broadcast so that the device identifiers can be seen by any device capable of receiving the control signals from base stations 105 and 106, such as population monitor 101 and wireless devices 102-104, these device identifiers are anonymous and actual mobile user identity information remains secured by the backend system of a wireless carrier operating either of base stations 105 or 106.

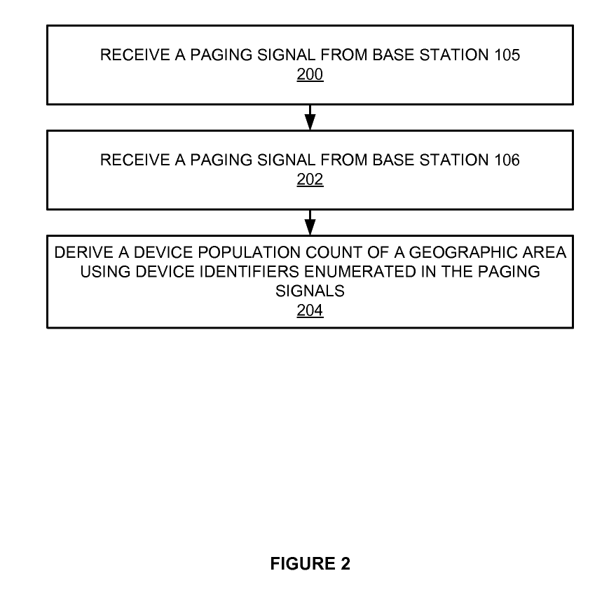

FIG. 2 illustrates the operation of wireless communication system 100 for deriving population counts and device flow characteristics on wireless communication networks. The operation begins with population monitor 101 receiving a control signal transmitted by base station 105 serving wireless sector 121 (step 200). Population monitor 101 also receives a control signal transmitted by base station 106 serving wireless sector 122 (step 202). Base stations 105 and 106 may be part of the same communication network as illustrated in FIG. 1 or may be part of different communication networks Likewise, base stations 105 and 106 may be operated by the same or different wireless carrier network operators and use different wireless protocols. For example, a first company may be the wireless carrier that operates a first communication network of which base station 105 is a part and uses a first wireless protocol while a second company operates a second communication network of which base station 106 is a part and uses a second wireless protocol.

Wireless device 102 is able to communicate with both base station 105 and base station 106. This also means that wireless device 102 is capable of receiving the control signals from both base station 105 and base station 106. Population monitor 101, like wireless device 102, is also capable of receiving the control signals from both base stations 105 and 106. However, population monitor 101 may be a passive device that does not exchange communications with either of base stations 105 and 106 aside from receiving the control signals sent from each.

Wireless devices 103-104 are also located in either of wireless sectors 121 and 122. Like wireless device 102, wireless devices 103-104 may be capable of communicating with both base stations 105 and 106, which may be the case if the same wireless carrier operates both of base stations 105 and 106. Alternatively, 103-104 may only be capable of communicating with either base station 105 and 106, which may be the case if different wireless carriers operate base stations 105 and 106.

Population monitor 101 then derives a population count of a geographic area using device identifiers enumerated within the control signals from base stations 105 and 106 (step 204). The geographic area includes the area covered by wireless sectors 121 and 122 because the control signals from base stations 105 and 106 that population monitor 101 receives apply to the area covered by wireless sectors 121 and 122. The device identifiers may include any identifier assigned to wireless devices 102-104 by base stations 105 and 106 or by some other part of a communication network that includes either of base stations 105, 106, or both. By counting the device identifiers broadcasted in the control signals from base stations 105 and 106, population monitor 101 is able to derive the population count for the geographic area.

In some embodiments, the population count may be a number of wireless devices in the geographic area. This population count may be an estimate of the number of wireless devices in the geographic area because the identifiers for certain wireless devices, such as dormant devices, may not be transmitted on either the first or second control signals during the time that population monitor 101 is configured to receive them.

In other embodiments, the population count may be an estimate of the number of people in the geographic area. A population count of this type may be derived by comparing the device identifiers enumerated in the first and second control signals or the device population count described above to information concerning wireless device penetration in the geographic area. For example, population monitor 101 may determine from the device identifiers that 100 wireless devices, including wireless devices 102-104, are located in the geographic area. If device penetration information indicates that the geographic area has a 50% wireless device penetration among people in the geographic area, then population monitor 101 may estimate that there are 200 people in the geographic area.

In some embodiments, other information may be used when determining the population count, such as wireless behavior information and environmental factor information (i.e. inactivity timer, dormant users, traffic channel usage, etc.), or any other information that may be useful to population monitor 101 when deriving the population count.

In some embodiments, population monitor 101 further derives flow characteristics of devices within the geographic area. For example, based on the device identifiers, population monitor 101 may determine that wireless device 102 started in wireless sector 121, moved to the overlapping area of sector 121 and 122, and then moved completely into wireless sector 122. This may be accomplished by population monitor 101 recognizing that a device identifier was first broadcast only in the control signal from base station 105, then broadcast in both of the control signal from base stations 105 and 106, and then only broadcast in the control signal from base station 106. Since the device identifiers are temporarily assigned, the population monitor 101 merely recognizes that a device with a certain device identifier moved between sectors, not that wireless device 102 specifically moved between sectors.

Additionally, the first and second control signals may include device identifiers that are assigned to devices at the time a device receives a traffic channel on either base station 105 and 106. Population monitor 101 can then determine a traffic channel usage by the wireless devices within the geographic area.

In some embodiments, population monitor 101 uses geographic coordinates of base stations 105 and 106 that are broadcast in the control signals from base stations 105 and 106, respectively, to determine the geographic area that is covered by wireless sectors 121 and 122. The geographic area may be determined as an estimate of the distance away from base stations 105 and 106 that the respective control signals are able to reach.

In some embodiments, multiple population monitors may be used in addition to population monitor system 101 in order to receive control signals over a larger geographic area.

Advantageously, the method of FIG. 2 described above allows population monitor 101 to collect broadcast information in order derive population count and mobile device flow characteristics regardless of the wireless carrier that operates base stations 105 and 106 or protocols used by base stations 105 and 106.

Referring back to FIG. 1, population monitor system 101 comprises Radio Frequency (RF) communication circuitry and an antenna. The RF communication circuitry typically includes an amplifier, filter, modulator, and signal processing circuitry. Population monitor system 101 may also include a user interface, memory device, software, processing circuitry, or some other communication components. Population monitor system 101 may be a dedicated device or may be part of a telephone, computer, e-book, mobile Internet appliance, wireless network interface card, media player, game console, or some other wireless communication apparatus—including combinations thereof.

Wireless communication device 102 comprises Radio Frequency (RF) communication circuitry and an antenna. The RF communication circuitry typically includes an amplifier, filter, modulator, and signal processing circuitry. Wireless communication device 102 may also include a user interface, memory device, software, processing circuitry, or some other communication components. Wireless communication device 102 may be a telephone, computer, e-book, mobile Internet appliance, wireless network interface card, media player, game console, or some other wireless communication apparatus—including combinations thereof.

Base stations 105 and 106 each comprise RF communication circuitry and an antenna. The RF communication circuitry typically includes an amplifier, filter, RF modulator, and signal processing circuitry. Base stations 105 and 106 may also comprise a router, server, memory device, software, processing circuitry, cabling, power supply, network communication interface, structural support, or some other communication apparatus.

Communication network 107 comprises network elements that provide communications services to wireless devices 102-104 through base stations 105-106. Communication network 107 may comprise switches, wireless access nodes, Internet routers, network gateways, application servers, computer systems, communication links, or some other type of communication equipment—including combinations thereof.

Communication links 111-112 use metal, glass, air, space, or some other material as the transport media. Communication links 111-112 could use various communication protocols, such as Time Division Multiplex (TDM), Internet Protocol (IP), Ethernet, communication signaling, CDMA, EVDO, WIMAX, GSM, LTE, WIFI, HSPA, or some other communication format—including combinations thereof. Communication links 111-112 could be direct links or may include intermediate networks, systems, or devices.

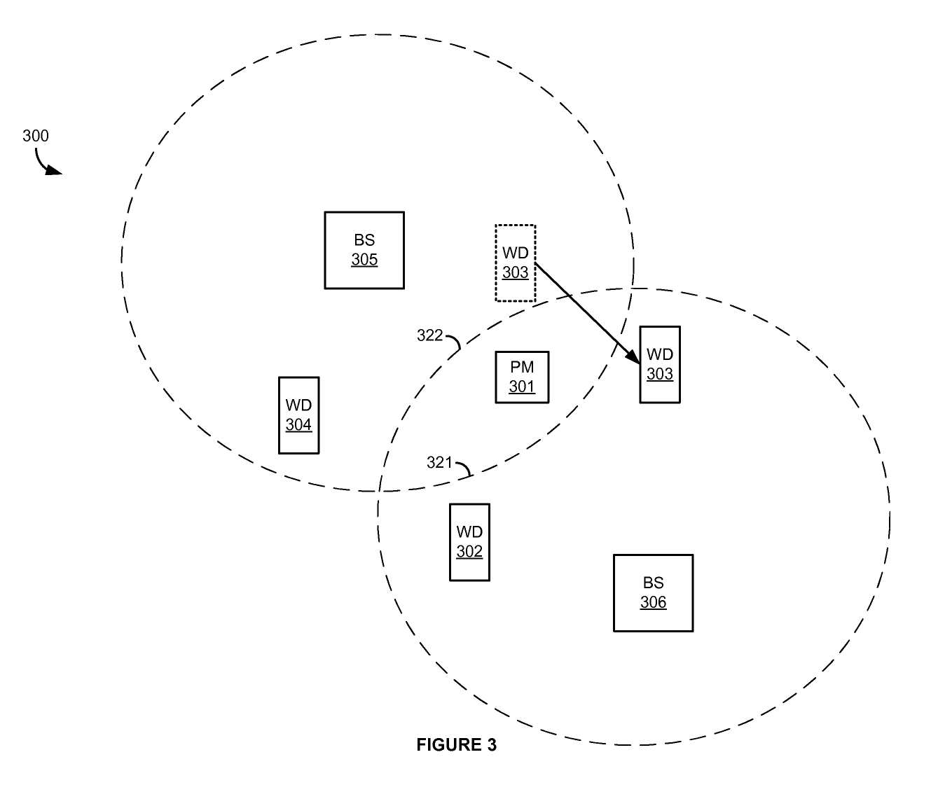

FIG. 3 illustrates wireless communication system 300 for deriving population counts and device flow characteristics on wireless communication networks. Wireless communication system 300 includes population monitor system 301, wireless communication devices 302-304, and base stations 305-306. Base station 305 covers wireless sector 321. Base station 306 covers wireless sector 322.

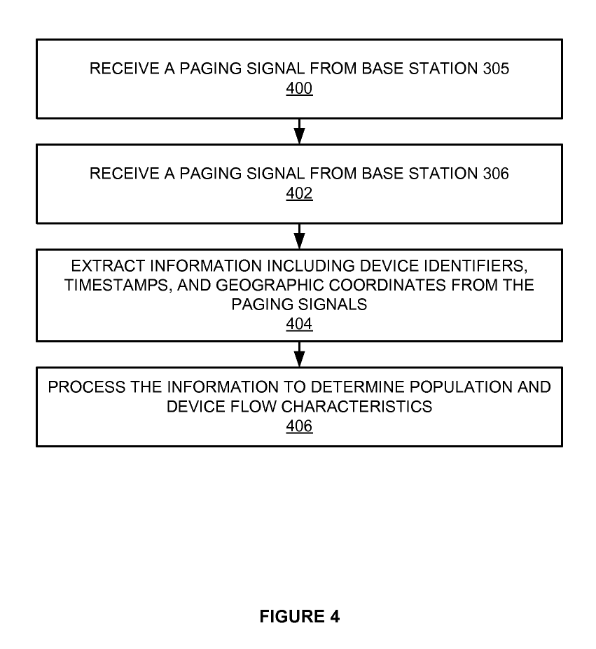

FIG. 4 illustrates the operation of wireless communication system 300 for deriving population counts and device flow characteristics on wireless communication networks. While not shown and described, wireless communication system 300 may include other base stations for other wireless carriers that cover the location where population monitor 301 is located. Thus, population monitor 301 may monitor the control signals from those other base stations as well.

In this example, base stations 305 and 306 are part of the same wireless communication network and use the same EVDO wireless protocol. More specifically, base stations 305 and 306 are part of the same subnet because the same Radio Network Controller (RNC) serves base stations 305 and 306. Wireless devices 302-304 are each assigned a Unicast Access Terminal Identifier (UATI) that uniquely identifies wireless devices 302-304 to the RNC. When wireless devices 302-304 require a traffic channel to exchange communications with either of base stations 305 and 306, each of wireless devices 302-304 are assigned a Mac-Index. A Mac-Index stays assigned to an individual wireless device as long as the wireless device is assigned a traffic channel. Both the UATI and the Mac-Index for a wireless device can be found in messages transferred in a control signal, such as traffic channel assignment and acknowledgment messages, transmitted from a base station.

In operation, population monitor 301 receives a control signal transmitted from base station 305 that is broadcasted into wireless sector 321 (step 400). Wireless devices 303 and 304 also receive the control signal from base station 305 because wireless device 303 and 304 are both located in wireless sector 321. Population monitor 301 similarly receives a control signal transmitted from base station 306 that is broadcasted into wireless sector 322 (step 402). Wireless device 302 also receives the control signal from base station 306 because wireless device 302 is located in wireless sector 322. Population monitor 301 is located in a border area where wireless sectors 321 and 322 overlap, thus, population monitor 301 is able to receive both the first and second control signals.

Population monitor 301 extracts any UATIs, Mac-Indexes, timestamps, and geographic coordinates for base stations 305-306 from the control signals from base station 305 and 306 (step 404). The above information is included in the control signals from base stations 305 and 306 if base stations 305 or 306 need to send control messages to wireless devices in wireless sectors 321 and 322. For example, if wireless device 303 requires a traffic channel for communications, the control signal from base station 305 will include the UATI for wireless device 303, which will direct the control message to wireless device 303. Also included is a Mac-Index for wireless device 303 for the traffic channel that base station 305 assigns to wireless device 303. At that point, population monitor 301 knows that a device exists in wireless sector 321 that has the UATI of wireless device 303 and that the device will be using a traffic channel. Thus, while population monitor 301 knows that wireless device 303 exists based on the UATI of wireless device 303, population monitor 301 is not able to determine the actual identity of wireless device 303. In other words, wireless device 303 merely exists as a number to population monitor 301.

In some situations, population monitor 301 may not know the geographic area covered by the control signals that population monitor 301 receives. Hence, the base station geographic coordinates contained within the control signals allow population monitor 301 to derive a geographic area that is covered by the wireless sectors 321 and 322. Additionally, population monitor 301 tracks timestamps to ascertain the timing information regarding the wireless devices in wireless sectors 321 and 322.

Therefore in this example, population monitor 301 recognizes that two wireless devices (303 and 304) are located in wireless sector 321 and one device (302) is located in wireless sector 322 without knowing the actual identity of wireless device 302-304. Likewise, population monitor 301 is able to recognize that wireless device 303 moves from wireless sector 321 to wireless sector 322 based on the fact that the UATI associated with wireless device 303 was on the control signal from base station 305 and then on the control signal from base station 306. Additionally, population monitor 301 is able to determine how often the three wireless devices use a traffic channel based on the Mac-Indexes included in the control signals.

As population monitor 301 receives the control signals from base stations 305 and 306, population monitor 301 processes the extracted information to determine population and device flow characteristics the geographic area covered by wireless sectors 321 and 322 (step 406). Population monitor 301 first determines an estimate of the device population count for the geographic area covered by wireless sectors 321 and 322. The device population is determined by ascertaining the number of device UATIs counted in wireless sectors 321 and 322 over a period of time and augmenting that number based on statistics that indicate a percentage of wireless devices that would be dormant during the period of time. For example, if 50% of devices may be dormant during the period of time, then the device population estimate would be twice the device number ascertained by population monitor 301.

After determining a device population estimate, a human population estimate can be determined using wireless device penetration for people in the area covered by wireless sectors 321 and 322. For example, if wireless device penetration is 80% then the human population estimate for the area is the device population estimate divided by 80%.

Furthermore, population monitor 301 can determine traffic channel usage rates based on the number of Mac-Indexes that are transferred on the control signals from base stations 305 and 306. Similarly, population monitor 301 can determine traffic channel usage rates and population flow during different times of day based on the timestamps. For example, population monitor 301 may recognize that population size and traffic channel usage spikes during certain hours of the day. Likewise, population monitor 301 may be able to determine other traffic channel usage statistics, such as a percentage of wireless devices that frequently request traffic channels or a percentage of wireless devices that rarely use traffic channels.

In some embodiments, two population monitors may be located on a border between two subnets with one population monitor located in the coverage area of one subnet and a second population monitor located in a coverage area of another subnet. The placement of these two population monitors allows the population monitors to recognize the change of a UATI for a wireless device as the wireless device moves from one subnet to the other.

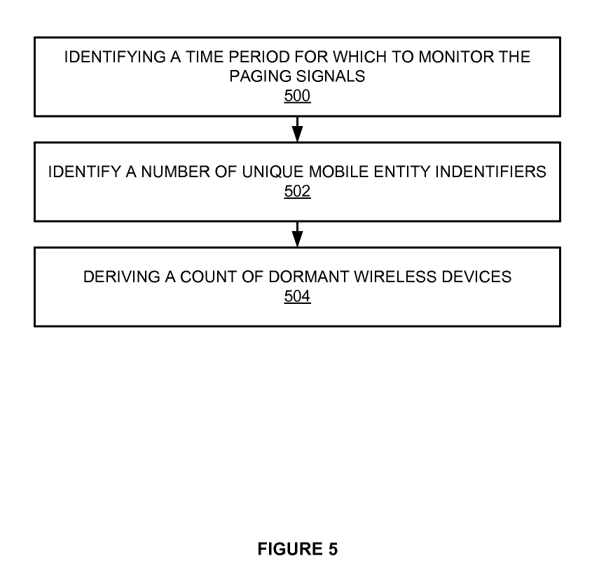

In some embodiments, rather than using an estimation of the number of dormant devices in the geographic area covered by wireless sectors 321 and 322, an actual count of the dormant wireless devices may be desirable. FIG. 5 illustrates the operation of wireless communication system 300 for deriving a count of dormant wireless devices.

Population monitor 301 identifies a time period within which to monitor the control signals from base station 305 and 306 (step 500). The time period is based on the fact that wireless devices are normally required to periodically transfer a location update message to a servicing base station. The time period is therefore chosen to be greater than or equal to a maximum amount of time that is allowed to elapse between when dormant wireless devices are required to transmit location update messages. For example, if dormant wireless devices are required to each transfer a location update message once every 30 minutes, the time period should be at least 30 minutes. Therefore, since each dormant wireless device is required to transfer a location update message every 30 minutes, a time period of at least 30 minutes will guarantee that each dormant wireless device will transfer a location update message at least once in the time period.

After transferring the location update messages, dormant wireless devices receive acknowledgement messages from the servicing base stations that acknowledge the receipt of the location update messages. Population monitor 301 identifies a number of unique mobile entity identifiers from the acknowledgement messages carried in the control signals from base station 305 and 306 during the time period (step 502). The mobile entity identifiers may be electronic serial numbers (ESN) or any other type of identifier that is assigned to a single device.

Accordingly, if wireless devices 302-304 are dormant devices, wireless devices 302-304 will each transfer at least one location update message to either base station 305 or 306 during the time period. Population monitor 301 will then recognize the acknowledgement messages transferred back to wireless devices 302-304 and identifies a mobile entity identifier for each of devices 302-304 and for any other dormant wireless devices in the geographic area covered by base stations 305 and 306. Population monitor 301 only identifies unique mobile entity identifiers so that a wireless device that transfers a location update message multiple times during the time period are not identified multiple times.

After identifying the unique mobile entity identifiers, population monitor 301 derives a count of dormant wireless devices during the time period based on the number of unique mobile entity identifiers (step 504). Accordingly, if wireless devices 302-304 are the only dormant wireless devices in the geographic area covered by base stations 305 and 306 during the time period, population monitor 301 identifies only three unique mobile entity identifiers and, thus, derives a count of 3 dormant devices. Population monitor 301 may then combine the count of dormant wireless devices with the count of active wireless devices during the time period achieved using the methods provided elsewhere in this description in order to derive a total count of active and dormant wireless devices.

After deriving the count of both active and dormant wireless devices, population monitor 301 can create a ratio of active wireless devices to dormant wireless devices in each monitored time period. Therefore, population monitor 301 can monitor and compare ratios for time periods occurring during evening hours, daytime hours, holiday hours, or any other time period of interest.

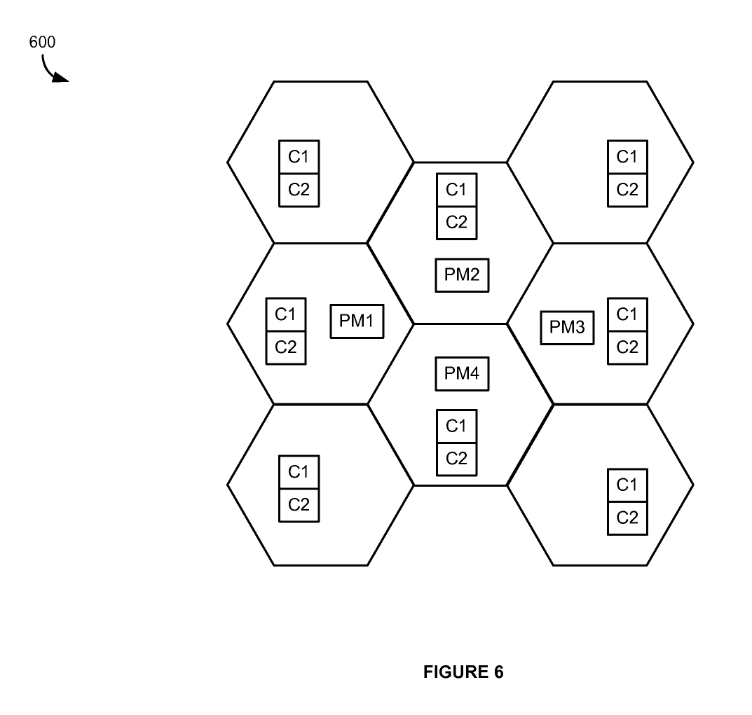

FIG. 6 illustrates wireless communication system 600 for deriving population counts and device flow characteristics on wireless communication networks. Wireless communication system 600 includes 8 hexagonal representations of wireless sectors. The hexagonal shapes are merely exemplary and, in reality, the wireless sectors may take any shape. Control signals from two base stations (C1 and C2), one base station operated by a first wireless carrier and the other by a second wireless carrier, covers each wireless sector. The base stations for the two wireless carriers may use the same wireless protocol or may use different wireless protocols.

Four of the wireless sectors further include a population monitor PM1-4 similar to population monitor 301 shown in FIG. 3. Each population monitor PM1-4 monitors the two control signals coming from base stations C1 and C2 in their respective wireless sector in a manner similar to that described above for FIG. 4. PM1-4 may share the data collected by each individual population monitor in order to determine a geographic area covered by the control signals received by PM1-4 and determine population estimates and flow statistics across the whole geographic area covered by PM1-4.

One or more of PM1-4 may determine the population estimates and flow characteristics. This may be performed by PM1-4 exchanging information over one over the first wireless carrier network, the second wireless carrier network, a third not pictured wired or wireless network, or any other way of sharing information between devices. Alternatively, PM1-4 may collect the information from the control signals in their respective wireless sectors and transfer the information to a remote system for processing. As before, this transference may be performed by PM1-4 exchanging information over the first wireless carrier network, the second wireless carrier network, a third not pictured wired or wireless network, by directly connecting PM1-4 to the remote system once PM1-4 are removed from their monitoring locations, or by any other way of transferring information between two devices.

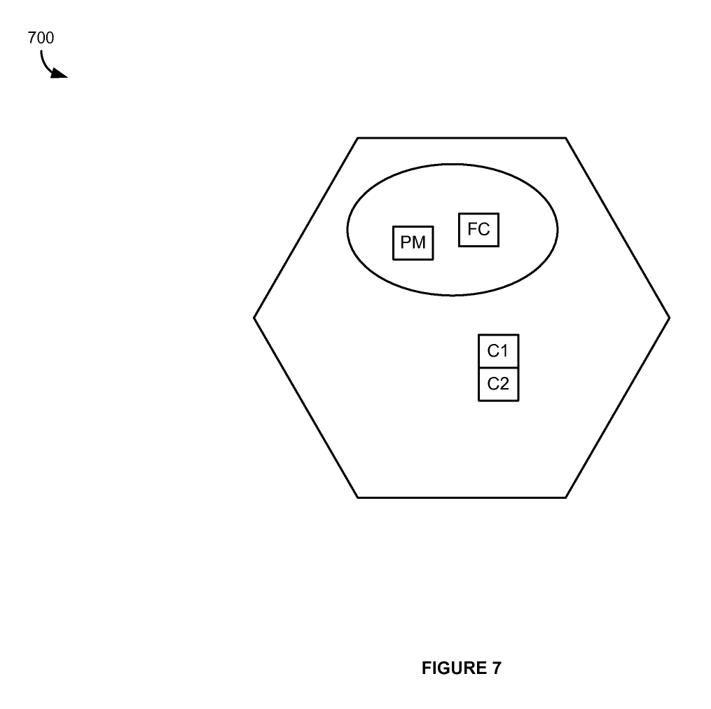

FIG. 7 illustrates wireless communication system 700 for deriving population counts and device flow characteristics on wireless communication networks. Wireless communication system 700 is similar to a single wireless sector shown in FIG. 5. While wireless communication system 500 was meant to show that multiple population monitors can cover a wider geographic area, wireless communication system 700 is meant to show how a population monitor can be used to determine population and device flow statistics for an area smaller than a single wireless sector. For example, a femtocell may be used to determine population and device flow statistics for the exposition hall in a convention center.

In addition to the wireless sector of wireless communication system 700 including a base station for each wireless carrier (C1 and C2), the wireless sector also contains a femtocell (FC), which is essentially a low powered base station covering a much smaller area indicated by the oval. In this example, the femtocell is a dummy femtocell that does provide wireless service but still transmits a control signal so that wireless devices within the coverage area will register with the femtocell.

A population monitor (PM) can be placed within the coverage area of the femtocell and collect control signal information from C1, C2, and the femtocell. Any information that is included in the control signals from either C1 or C2 that is also included in the control signal from the femtocell would mean that the information is for a wireless device located within the coverage area of the femtocell. Therefore, in order to determine the population count and flow statistics for the geographic area covered by the femtocell, the population monitor only uses information for wireless devices that have information included both in the femtocell's control signal and in the control signals of C1 or C2.

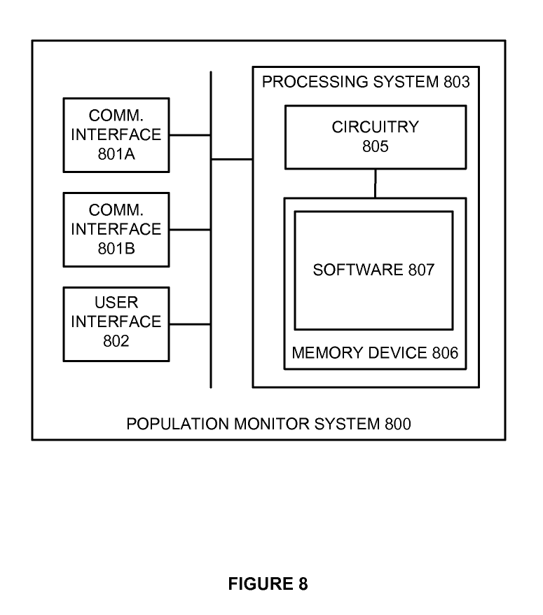

FIG. 8 illustrates population monitor system 800 for deriving population counts and device flow characteristics on wireless communication networks. Population monitor system 800 is an example of population monitor systems 101 and 301, although systems 101 and 301 could use alternative configurations. Population monitor system 800 comprises wireless communication interface 801, user interface 802, and processing system 803. Processing system 803 is linked to wireless communication interface 801 and user interface 802. Processing system 803 includes processing circuitry 805 and memory device 806 that stores operating software 807. Population monitor system 800 may include other well-known components such as a battery and enclosure that are not shown for clarity. Population monitor system 800 may be an independent system or part of a telephone, computer, mobile Internet appliance, media player, game console, wireless network interface card, or some other wireless communication apparatus—including combinations thereof.

Wireless communication interface 801 comprises RF communication circuitry and an antenna. The RF communication circuitry typically includes an amplifier, filter, RF modulator, and signal processing circuitry. Wireless communication interface 801 may also include a memory device, software, processing circuitry, or some other communication device. Wireless communication interface 801 may use various protocols, such as CDMA, EVDO, WIMAX, GSM, LTE, WIFI, HSPA, or some other wireless communication format.

Wireless communication interface 801 is configured to receive a first control signal transmitted by a first base station serving a first wireless sector and receive a second control signal transmitted by a second base station serving a second wireless sector.

User interface 802 comprises components that interact with a user to receive user inputs and to present media and/or information. User interface 802 may include a speaker, microphone, buttons, lights, display screen, touch screen, touch pad, scroll wheel, communication port, or some other user input/output apparatus—including combinations thereof. User interface 802 may omitted in some examples.

Processing circuitry 805 comprises microprocessor and other circuitry that retrieves and executes operating software 807 from memory device 806. Memory device 806 comprises a non-transitory storage medium, such as a disk drive, flash drive, data storage circuitry, or some other memory apparatus. Processing circuitry 805 is typically mounted on a circuit board that may also hold memory device 806 and portions of communication interface 801 and user interface 802. Operating software 807 comprises computer programs, firmware, or some other form of machine-readable processing instructions. Operating software 807 may include an operating system, utilities, drivers, network interfaces, applications, or some other type of software. When executed by processing circuitry 805, operating software 807 directs processing system 803 to operate population monitor system 800 as described herein. In particular, operating software 807 directs processing system 803 to derive a population count of a geographic area using device identifiers enumerated within the first and second control signals.

It should be understood that communication interfaces 801A and B may be part of a receiver system that is separate from processing system 803. Thus, processing system 803 and the receiver system may be connected by a communication link that may include various communication networks to exchange information. For example, the receiver system may be placed at a monitor location and the information received from the control signals at the monitor location may be transferred over a communication network to processing system 803. The information may be transferred in real time, periodically, or stored in a memory at the receiver system for transference at a later time. Alternatively, the two systems may be located very near one another. For example, receiver system may be contained within a device similar to a wireless aircard for a laptop and processing system 803 may be part of the laptop itself running software necessary to process data from the receiver system. A communication link between the receiver system and processing system 803 may include various interfaces, such as Universal Serial Bus (USB), needed to exchange communications between an aircard and a laptop.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of analyzing communication activity, comprising:
receiving a first control signal transmitted by a first base station serving a first wireless sector;
receiving a second control signal transmitted by a second base station serving a second wireless sector;
deriving a count of wireless devices operating within a geographic area using device identifiers enumerated within the first and second control signals.

2. The method of claim 1, further comprising:
determining a flow of devices between the first and second wireless sectors from the device identifiers enumerated within the first and second control channels.

3. The method of claim 1, further comprising:
determining communication channel usage information for devices in the first and second wireless sectors from the device identifiers enumerated within the first and second control channels.

4. The method of claim 1, wherein the first wireless sector geographically overlaps the second wireless sector.

5. The method of claim 1, wherein each of the device identifiers comprises a unique identifier for a wireless device associated with a subnet of a wireless communication network.

6. The method of claim 1, wherein each of the device identifiers comprises a unique identifier assigned to a wireless device when the wireless device is assigned a traffic channel from the wireless access node and is unassigned when the traffic channel is released.

7. The method of claim 1, further comprising:
defining the geographic area based upon first geographic coordinates received from the first base station via the first control channel and second geographic coordinates received from the second base station via the second control channel.

8. The method of claim 1, wherein the first base station has a shorter wireless signal range than the second base station.

9. The method of claim 1, further comprising:
deriving a population count within the geographic area using the device identifiers enumerated within the first and second control signals.

10. The method of claim 1, further comprising:
identifying a time period within which to monitor the first and second control signals, wherein the time period is greater than or equal to a maximum amount of time that is allowed to elapse between when dormant wireless devices are required to transmit location update messages;
identifying a number of unique mobile entity identifiers from acknowledgement messages carried in the first and second control signals during the time period, wherein the acknowledgment messages acknowledge the location update messages;
deriving a count of dormant wireless devices during the time period based on the number of unique mobile entity identifiers.

11. A communication analysis system, comprising:
a wireless communication interface configured to receive a first control signal transmitted by a first base station serving a first wireless sector and receive a second control signal transmitted by a second base station serving a second wireless sector; and
a processing system configured to derive a count of wireless devices operating within a geographic area using device identifiers enumerated within the first and second control signals.

12. The communication analysis system of claim 11, further comprising:
the processing system configured to determine a flow of devices between the first and second wireless sectors from the device identifiers enumerated within the first and second control channels.

13. The communication analysis system of claim 11, further comprising:
the processing system configured to determine communication channel usage information for devices in the first and second wireless sectors from the device identifiers enumerated within the first and second control channels.

14. The communication analysis system of claim 11, wherein the first wireless sector geographically overlaps the second wireless sector.

15. The communication analysis system of claim 11, wherein each of the device identifiers comprises a unique identifier for a wireless device associated with a subnet of a wireless communication network.

16. The communication analysis system of claim 11, wherein each of the device identifiers comprises a unique identifier assigned to a wireless device when the wireless device is assigned a traffic channel from the wireless access node and is unassigned when the traffic channel is released.

17. The communication analysis system of claim 11, further comprising:
the processing system configured to define the geographic area based upon first geographic coordinates received from the first base station via the first control channel and second geographic coordinates received from the second base station via the second control channel.

18. The communication analysis system of claim 11, wherein the first base station has a shorter wireless signal range than the second base station.

19. The communication analyzing system of claim 11, further comprising:
the processing system configured to:
identify a time period within which to monitor the first and second control signals, wherein the time period is greater than or equal to a maximum amount of time that is allowed to elapse between when dormant wireless devices are required to transmit location update messages;
identify a number of unique mobile entity identifiers from acknowledgement messages carried in the first and second control signals during the time period, wherein the acknowledgment messages acknowledge the location update messages;
derive a count of dormant wireless devices during the time period based on the number of unique mobile entity identifiers.

20. A computer readable medium having instructions stored thereon for operating a communication analysis system wherein the instructions, when executed by the communication analysis system, direct the communication analysis system to:
receive an indication of device identifiers enumerated in a first control signal transmitted by a first base station serving a first wireless sector and a second control signal transmitted by a second base station serving a second wireless sector;
derive a count of wireless devices operating within a geographic area using the device identifiers enumerated within the first and second control signals.
